(19) United States
(12) Patent Application Publication
(10) Pub. No.: US 2009/0089488 A1
(43) Pub. Date: Apr. 2, 2009

(54) MEMORY SYSTEM, MEMORY READ METHOD AND PROGRAM

(75) Inventor: Keisuke Yasui, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/235,428

(22) Filed: Sep. 22, 2008

(30) Foreign Application Priority Data
Sep. 28, 2007 (JP) 2007-255933

(51) Int. Cl. G06F 12/02

(52) U.S. Cl. 711/103; 711/E12.008

(57) ABSTRACT

According to one embodiment, there is disclosed a memory system comprising a flash memory unit which suspends a write operation to execute a read operation when receiving a suspend command during a write operation, a CPU, an OS which includes a device driver, a TLB which has a page table for conversion from a virtual address to a physical address, and an application program which makes a TLB setting request with respect to the device driver when receiving a read command under the control of the CPU and the OS, acquires address information read from the page table of the TLB by the device driver in response to the setting request, and executes read directly with respect to the flash memory unit using the acquired address information without using the device driver.

### CROSS-REFERENCE TO RELATED APPLICATIONS

This application is based upon and claims the benefit of priority from Japanese Patent Application No. 2007-255933, filed Sep. 28, 2007, the entire contents of which are incorporated herein by reference.

### BACKGROUND

1. Field

One embodiment of the present invention relates to a memory system including a flash memory, which suspends write to read data when receiving a suspend command during a write operation, to a memory read method, and to a program.

2. Description of the Related Art

In recent years, many kinds of memory devices have been developed and come into wise use. A conventional NOR flash memory given as one of the foregoing devices has the following problem. Specifically, time is taken to write/erase data, and during this operation, data read is not executed. Recently, a NOR flash memory having a write suspend function and an erase suspend function has been developed. During write or erase operation, a suspend command is issued to suspend processing, and thereby, data read is temporarily enabled. There has beer known the following document describing a method of executing write to a flash memory.

Jpn. Pat. Appln. KOKAI Publication No. 2004-30438 discloses the rewrite procedure of a microcomputer having a built-in nonvolatile memory such as flash memory, specifically, of the nonvolatile memory.

However, according to the conventional technique disclosed in the Foregoing Publication, there is no description how to use a translation look-aside buffer (TLB) in read and write operations. In addition, there is no description how to execute a write operation with respect to the foregoing NOR flash memory having the write suspend function. Thus, there is a problem that it can not be seen how to execute a read at high speed using the characteristic of the NOR flash memory having the write suspend function.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of a memory system according to one embodiment of the present invention;

FIG. 2 is a view to explain the flow of executing a read operation directly on a flash memory when an application program uses a TLB in the memory system according to one embodiment of the present invention;

FIG. 3 is a view to explain the flow of executing read/write operations when an application program uses a device driver in the memory system according to one embodiment of the present invention;

FIG. 4 is a flowchart to explain one example when an application program directly executes a read operation with respect to a flash memory in the memory system according to one embodiment of the present invention;

FIG. 5 is a flowchart to explain one example when a write operation is executed with respect to a flash memory in the memory system according to one embodiment of the present invention; and

FIG. 6 is a flowchart to explain one example when an application program executes a read operation with respect to a flash memory via a device driver.

### DETAILED DESCRIPTION

Various embodiments according to the invention will be described hereinafter. In general, according to one embodiment of the invention, there is provided a memory system comprising: a flash memory unit which suspends a write operation to execute a read operation when receiving a suspend command during a write operation; a CPU; an OS which includes a device driver; a TLB which has a page table for conversion from a virtual address to a physical address; and an application program which makes a TLB setting request with respect to the device driver when receiving a read command under the control of the CPU and the OS, acquires address information read from the page table of the TLB by the device driver in response to the setting request, and executes read directly with respect to the flash memory unit using the acquired address information without using the device driver.

A read operation is executed directly with respect to the flash memory without using the device driver, and thereby, high-speed read is possible. A TLB error is intentionally generated to properly manage an issuance of a suspend command.

Embodiments of the invention will be hereinafter described with reference to the accompanying drawing.

### ONE EXAMPLE OF MEMORY SYSTEM ACCORDING TO ONE EMBODIMENT OF THE PRESENT INVENTION

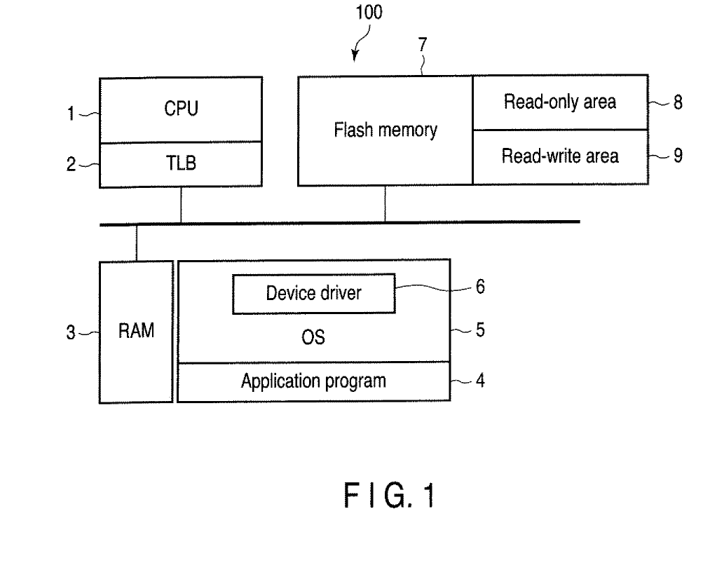

FIG. 1 is a block diagram showing the configuration of a memory system according to one embodiment of the present invention A memory system 100 according to one embodiment of the present invention includes a CPU 1, a translation look-aside buffer (TLB) 2, a RAM 3, an application program 4, an operation system (OS) 5 and a device driver 6. Specifically, the CPU 1 controls the whole operation. The TLB 2 has a page table for conversion from virtual address to physical address. The application program 4 is stored in the RAM 3. The operating system (OS) 5 is stored in the RAM 3. The device driver 6 is included in the OS 5.

The memory system 100 further includes a flash memory 7, a read-only area 8 and a read/write area 9. When receiving a suspend command during a write operation, the flash memory 9 suspends the write operation to execute a read operation. The read-only area 8 and the read/write area 9 are used as a part of a memory area of the flash memory 7.

Specifically, in the memory system 100, the OS 5 is loaded in the RAM 3, and the application program is executed under the OS 5. In the flash memory 7, the read-only area 8 and the read/write area 9 are independently accessed. In this case, the read-only area 8 and the read/write area 9 are managed in a state that the memory area is divided into two by the application program 4.

The NOR flash memory 7 is used having the following function (program suspend function or erase suspend function). According to the function, the flash memory suspends an operation during a write/erase operation to temporarily execute a read.

(Read and Write Operations)

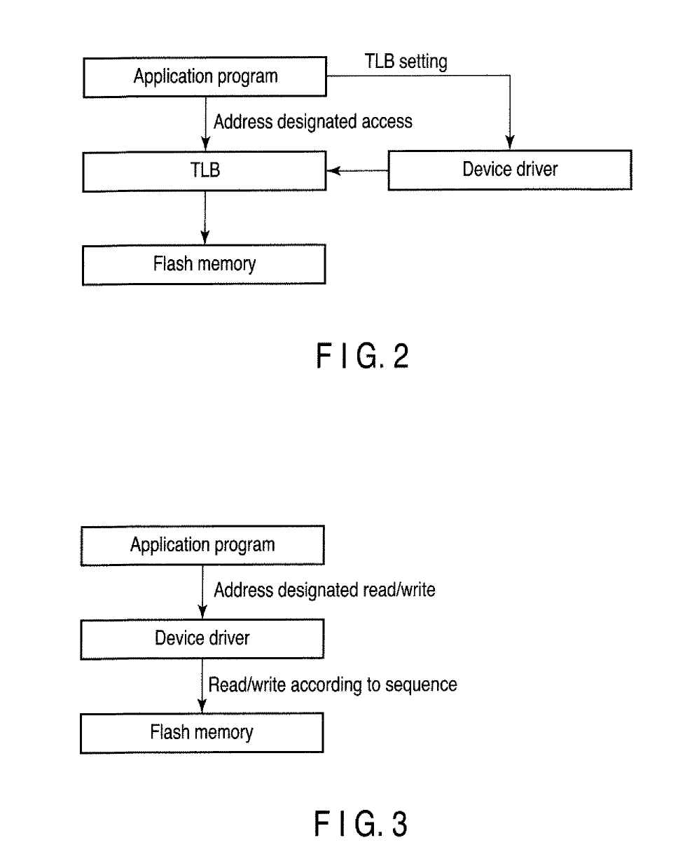

The read and write operations will be hereinafter described. FIG. 2 is a view to explain the flow of execution using the TLB by the application program in the memory system according to one embodiment of the present invention. FIG. 3 is a view to explain the flow of execution using the device driver by the application program in the memory system according to one embodiment of the present invention.

Outline of Read and Write Operations

Specifically, the memory system according to one embodiment of the present invention executes the following operation when accessing the read-only area 8. As shown in FIG. 2, when receiving a read command under the control of the CPU 1 and the OS 5, the application program 4 makes a setting request of the TLB 2 to the device driver 6. The device driver 6 acquires address information from a page table of the TLB 2 in accordance with the setting request. The application program 4 rapidly executes a read operation directly on the read-only area 8 of the flash memory using the acquired address information without using the device driver 6.

On the other hand, as depicted in FIG. 3, the memory system 100 makes access to the read/write area 9 via the device driver. The device driver 6 executes a write operation according to a write sequence of the flash memory 7. In this case, the write operation process takes more time as compared with the case where the application program 4 directly executes a read operation with respect to the read-only area of the flash memory 7.

Read Operation

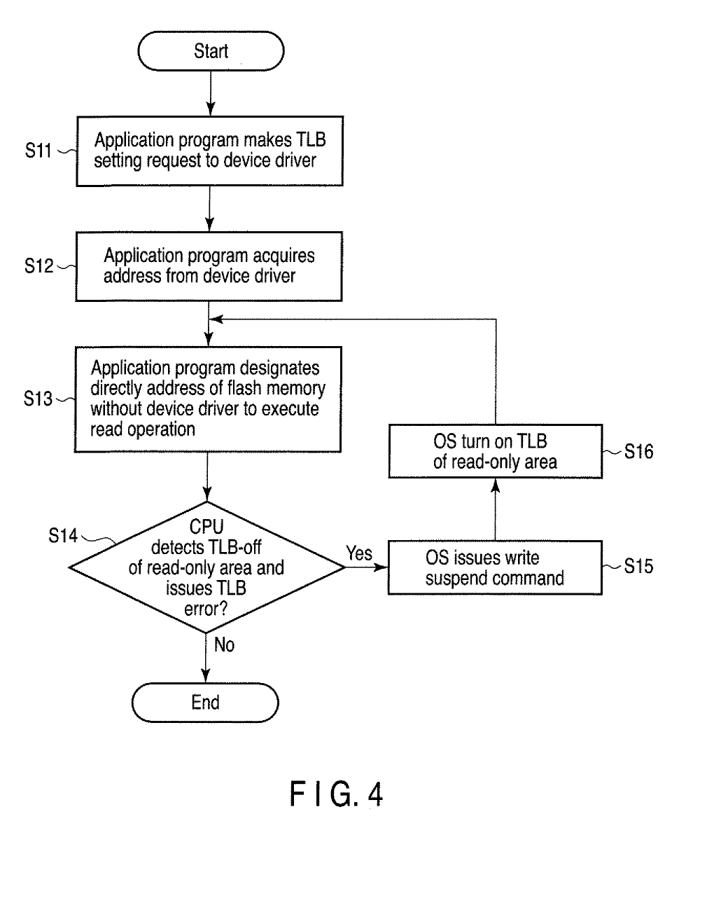

The procedure of executing a read operation directly on the flash memory by the application program without the foregoing device driver will be described with reference to a flowchart of FIG. 4.

FIG. 4 is a flowchart to explain the procedure of directly executing a read operation directly on the flash memory 7 by the application program in the memory system 100 according to one embodiment of the present invention.

When the OS 5 receives a read command of the read-only area 8, the application program 4 requests TLB setting to the device driver 6 (step S11). This is executed once only, and thus, there is no need to make a request every read operation. As a result, the device diver 6 reads the corresponding physical address from the TLB 2 having the page table for conversion from a virtual address to a physical address. Then, the application program 4 acquires the address information from the device driver (step S12). This procedure may be executed only once.

The application program 4 directly designates the address of the flash memory without using the device driver 6 to read information (step S13). Usually, the read operation succeeds.

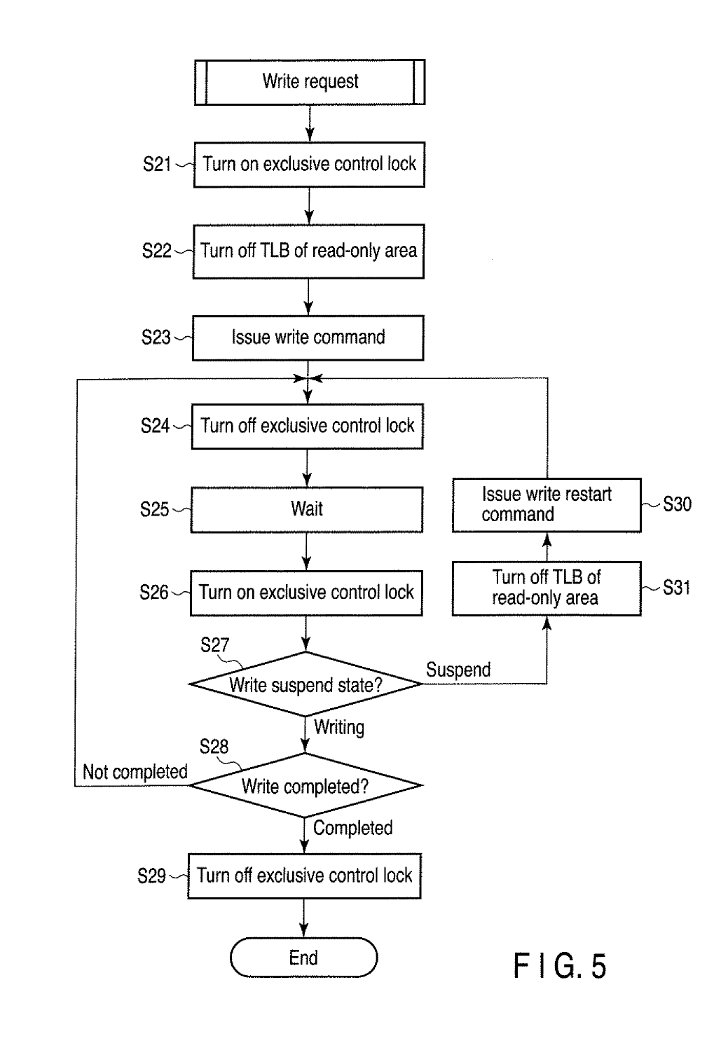

However, in this case, the write operation is being executing as described later in FIG. 5, and the CPU 1 detects that the TLB of the read-only area 8 is in an off state (invalid), and thereby, a TLB error exception is generated. When detecting the TLB error exception (step S14), the OS 5 issues a write suspend command, and then, supplies it to the flash memory 7 (step S15). As a result, the flash memory 7 suspends the write operation. Thereafter, the OS 5 turns on the TLB 2 of the read-only area 8 (step S16). As a result, the CPU returns from the TLB error exception enable a read operation on the read-only area 8.

The foregoing direct read operation from the read-only area 8 of the flash memory 7 by the application program is not executed via the device driver 6. Therefore, this serves to prevent a reduction of access speed, which is a factor given by the device driver 6.

Write Operation

The procedure of managing an issuance of the suspend command by generating the TB error will be hereinafter described with reference to a flowchart of FIG. 5. FIG. 5 is a flowchart to explain the procedure of executing a write operation on the flash memory in the memory system according to one embodiment of the present invention.

In the memory system 100, when receiving a write command to the write area 9, the OS 5 turns on an exclusive control lock of inhibiting a process switch (step 321). Then, the OS 5 turns off (makes invalid) the TLB 2 of the read-only area 8 (step S22). The OS issues a write command to the flash memory (step 323) to turn off the exclusive control lock (step S24). Thereafter, the CPU 1 and the OS 5 wait for a predetermined time (step S25).

Thereafter, the OS 5 turns on the exclusive control lock (step S26). However, in this case, there is a possibility that other process executes a read operation for this wait operation. For this reason, the OS 5 determines whether or not the write operation is in a suspended state at present (step S27). If it is determined that the write operation is in a suspended state, the OS 5 turns off the TLB 2 of the read-only area 8 (step S31). Thereafter, the OS 5 issues a command to restart the write operation, and thereby, the write operation is continued (step S30).

Conversely, if the write operation is not in a suspended state in step S27, the procedure returns to step S24 to continue the write operation, the procedure is repeated until the write operation is completed (step S28). When the write operation is completed, the OS 5 turns off the exclusive control lock to return to the initial state (step S29). The erase procedure has the same sequence as the write procedure.

In the procedure of FIG. 5, in step S22, the TLB of the read-only area is turned off, and thereby, if the read operation collides with the write operation, a TLB error exception is generated. In this way, the OS 5 issues a suspend command, and the, supplies it to the flash memory. Therefore, the write operation is suspended, and thus, high-speed read is possible.

<One Example of Read Operation Using Device Driver>

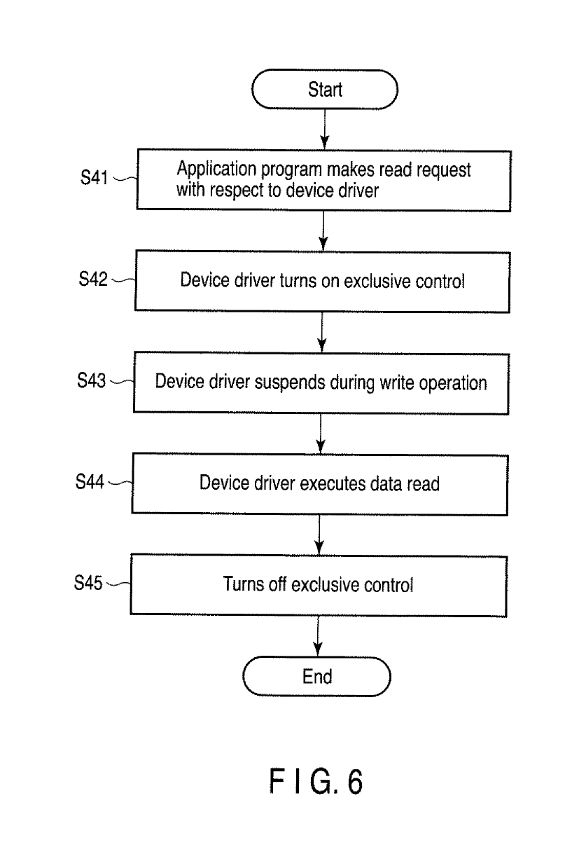

For reference, one procedure of executing a read operation by the application program 4 without directly accessing the flash memory 7 will be described with reference to a flowchart of FIG. 6.

FIG. 6 is a flowchart to explain one procedure of accessing a flash memory via a device driver to execute a read operation by an application program.

Specifically, in a system memory 100, when receiving a read command, the application program 4 makes a read request with respect to the device driver 6 under the control of a CPU 1 and an OS 5 (step S41). In response to the request, the device driver 6 turns on exclusive control (step S42). Then, the device driver 6 suspends if a write operation is made (step S43). The device driver 6 executes a data read operation (step S44). The device driver 6 turns off the exclusive control (step S45).

According to the flowchart of FIG. 6, when a NOR flash memory 7 having a program suspend function is used, the application program 4 dose not directly accesses the flash memory 7 to execute a read operation. In this case, the device driver 6 executes the read operation with respect to the flash memory 7. In other words, state management is made in the device driver. The NOR flash memory is directly accessed according to address designation, and thereby, high-speed read is possible. However, the device driver is held between application program and the flash memory, and thereby, the read speed is reduced to about 1/10.

According to the foregoing on embodiment of the present invention, the application program 4 can directly access the read-only area 8 as seen from FIG. 4. Thus, the read speed is intactly high speed, and response is improved.

If the suspend command is not used in the NOR flash memory, during write or erase operation, the read operation is not executed. For this reason, read operation response becomes worse. However, the flash memory having the following functions is used, and thereby it is possible to solve the problem that speed is reduced. One is a program suspend function, another is an erase suspend function, and still another is a function of changing the operation to a temporarily readable state during operation.

If the NOR flash memory 7 having the program suspend function is used, all of read/write accesses are executed via the device driver 6, and thereby, the read speed is reduced to about 1/10.

According to one embodiment of the present invention described in the flowcharts of FIG. 4 and FIG. 5, the application program can directly access the read-only area. Therefore, the read speed is maintained high speed, and response is improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A memory system comprising:
a flash memory unit which suspends a write operation to execute a read operation when receiving a suspend command during a write operation;
a CPU;
an OS which includes a device driver;
a TLB which has a page table for conversion from a virtual address to a physical address; and
an application program which makes a TLB setting request with respect to the device driver when receiving a read command under the control of the CPU and the OS, acquires address information read from the page table of the TLB by the device driver in response to the setting request, and executes read directly with respect to the flash memory unit using the acquired address information without using the device driver.

2. The system according to claim 1, wherein when detecting a TLB error generated by the CPU in a read operation on the flash memory unit by the application program, the OS issues a suspend command, and supplies it to the flash memory unit, and thereby, suspends the write operation executed by the flash memory unit.

3. The system according to claim 2, wherein the OS sets invalid a read-only area of the TLB when executing a write operation so that the CPU issues a TLB error when the application program executes a read while the flash memory unit executes a write operation.

4. The system according to claim 1, wherein the flash memory unit is a NOR flash memory device.

5. A memory read method used for a flash memory, which suspends a write operation when receiving a suspend command during a write operation to execute a read operation, comprising:
preparing the flash memory, a CPU, an OS including a device driver and a TLB having a page table for conversion from a virtual address to a physical address;
the application program making a setting request of the TLB with respect to the device driver when receiving a read command under control of the CPU and the OS;
the device driver acquiring address information from the page table of the TLB in response to the setting request; and
the application program directly reading the flash memory unit using the acquired address information without the device driver.

6. The method according to claim 5, wherein when detecting a TLB error generated by the CPU in a read operation on the flash memory by the application program, the OS issues a suspend command, and supplies it to the flash memory, and thereby, suspends the write operation executed by the flash memory.

7. The method according to claim 6, wherein the OS sets invalid a read-only area of the TLB when executing a write operation so that the CPU issues a TLB error when the application program executes a read while the flash memory unit executes a write operation.

8. The method according to claim 5, wherein the flash memory is a NOR flash memory device.

9. A program executable on a memory system including a CPU, a TLB having a page table for conversion from a virtual address to a physical address and a flash memory unit suspending a write operation to execute a read operation when receiving a suspend command during a write operation, comprising:
setting a read-only area of the TLB to a invalid state when receiving a write command to execute a write operation;
the CPU issuing a TLB error when detecting that the read-only area is set to invalid by the TLB when receiving a read command to execute a read operation; and
issuing the suspend command and supplying it to the flash memory unit when detecting the TLB error, so that a write operation executed by the flash memory unit is suspended.
